(19) United States
(12) Patent Application Publication
(10) Pub. No.: US 2025/0307674 A1
(43) Pub. Date: Oct. 2, 2025

(54) PARAMETER ESTIMATION DEVICE AND PARAMETER ESTIMATION METHOD

(71) Applicant: TOYOTA JIDOSHA KABUSHIKI KAISHA, Aichi-ken (JP)

(72) Inventors: Koichi NISHITANI, Toyonaka-shi (JP); Yoshio TAKIZAWA, Tokyo-to (JP); Shigefumi TOKUDA, Susono-shi (JP); Masafumi KADOI, Chita-shi (JP)

(21) Appl. No.: 19/090,395

(22) Filed: Mar. 26, 2025

(30) Foreign Application Priority Data
Apr. 2, 2024 (JP) 2024-059697

(51) Int. Cl. G06N 5/043

(52) U.S. Cl. CPC G06N 5/043

(57) ABSTRACT

A parameter estimation device repeatedly executes estimation process for estimating a parameter using an ensemble Kalman filter based on measured value data a plurality of times. Further, in the estimation process, the parameter estimation device performs at least one of increasing the number of ensemble members of the ensemble Kalman filter from the number of members in the estimation process related to the previous iteration and decreasing the magnitude of the system noise of the ensemble Kalman filter from the system noise in the estimation process related to the previous iteration, and sets an initial value of the parameter using the estimation result of the parameter by the estimation process related to the previous iteration.

### CROSS-REFERENCE TO RELATED APPLICATION

The present application claims priority under 35 U.S.C. § 119 to Japanese Patent Application No. 2024-059697, filed on Apr. 2, 2024, the contents of which application are incorporated herein by reference in their entirety.

### TECHNICAL FIELD

The present disclosure relates to a technique for estimating parameters of a simulation model for executing a multi-agent simulation.

### BACKGROUND

Simulation models that perform simulations of various events generally have parameters that are tuned. In order for the simulation model to execute accurate simulation, it is required to estimate more appropriate parameters. Conventionally, various techniques for estimating parameters have been proposed. For example, Patent Document 1 discloses a technique related to a Bayesian inference method of a mixture model for estimating a posterior distribution of parameters of the mixture model. In addition, as documents showing the technical level of the present technical field, there are the following Patent Documents 2 and 3.

### LIST OF RELATED ART

Patent Document 1: Japanese Patent Application Laid-Open No. 2001-202358
Patent Document 2: Japanese Patent Application Laid-Open No. 2015-052491
Patent Document 3 International Publication WO 2017/170086

### SUMMARY

As one of the simulation models, there is a simulation model (hereinafter, referred to as a “multi-agent model”) that executes a multi-agent simulation. The multi-agent simulation reproduces a target event by simulating the operation of a plurality of agents that interact with each other. Therefore, in the multi-agent model, a model having a parameter for each of a plurality of agents is given.

Conventionally, a technique for effectively estimating parameters in a multi-agent model has not been sufficiently studied. Since the multi-agent model has a parameter for each of the models of the plurality of agents, the number of parameters to be estimated is very large. The parameters may also be mutually influencing. Therefore, when the conventional technique of estimating the parameters in a brute-force manner is applied, the calculation time may become enormous.

An object of the present disclosure is to provide a technique that enables effective estimation of parameters of a multi-agent model.

A first aspect relates to a parameter estimation device for estimating a parameter of a simulation model that executes a multi-agent simulation.

The parameter estimation device includes processing circuitry. The processing circuitry is configured to acquire measured value data related to a target event of the multi-agent simulation and repeatedly execute an estimation process for estimating a parameter using an ensemble Kalman filter based on the measured value data through a plurality of execution steps of the multi-agent simulation a plurality of times. Further, in the estimation process, the processing circuitry performs at least one of increasing a number of ensemble members of the ensemble Kalman filter from the number of ensemble members in the estimation process in a previous iteration and decreasing magnitude of system noise of the ensemble Kalman filter from the system noise in the estimation process in a previous iteration, and sets an initial value of the parameter using the estimation result of the parameter by the estimation process in a previous iteration.

A second aspect relates to a parameter estimation method for estimating a parameter of a simulation model that executes a multi-agent simulation by a computer.

The parameter estimation method includes a computer acquiring measured value data related to a target event of the multi-agent simulation, and repeatedly executing estimation process for estimating a parameter using an ensemble Kalman filter based on the measured value data through a plurality of execution steps of the multi-agent simulation a plurality of times. The parameter estimation method further includes, in the estimation process, performing at least one of increasing a number of ensemble members of the ensemble Kalman filter from the number of ensemble members in the estimation process in a previous iteration and decreasing magnitude of system noise of the ensemble Kalman filter from the system noise in the estimation process in a previous iteration, and setting an initial value of the parameter using an estimation result of the parameter by the estimation process in a previous iteration.

According to the present disclosure, it is possible to effectively estimate parameters of a multi-agent model.

### BRIEF DESCRIPTION OF DRAWINGS

FIG. 1 is a diagram showing an overview of a multi-agent model;

FIG. 2 is a diagram showing an example of a hardware configuration of a parameter estimation device according to an embodiment;

FIG. 3 is a diagram showing an overview of estimation process executed by the parameter estimation device according to the embodiment;

FIGS. 4A and 4B are diagrams showing a change in estimation result of the estimation process due to a difference in magnitude of system noise of an ensemble Kalman filter;

FIG. 5 is a diagram showing an overview of the estimation process repeatedly executed a plurality of times by the parameter estimation device according to the embodiment;

FIG. 6 is a flowchart showing a processing flow of processing executed by the parameter estimation device according to the embodiment; and

FIG. 7 is a flowchart showing a processing flow of processing executed by the parameter estimation device according to the embodiment.

### DETAILED DESCRIPTION

Hereinafter, an embodiment of the present disclosure will be described with reference to the accompanying drawings. In the drawings, the same or corresponding elements are denoted by the same reference numerals, and the description thereof will be simplified or omitted.

### 1. Multi-Agent Model

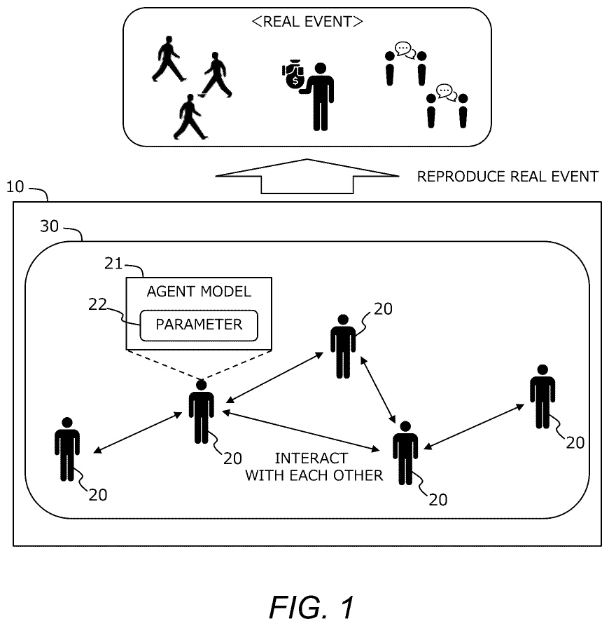

FIG. 1 is a diagram showing an overview of a simulation model 10 (multi-agent model 10) that executes multi-agent simulation. The multi-agent simulation reproduces a target event by simulating the operation of a plurality of agents 20 that interact with each other. Examples of the target event include real events such as people flow, purchasing behavior, and information diffusion. Each of the plurality of agents 20 represents a component of the target event. For example, when the target event is a people flow, each agent 20 represents one person forming the people flow. Each agent 20 may represent various things such as a person, an animal, a vehicle, and a robot in accordance with a target event.

The multi-agent model 10 includes a model 21 (agent model 21) that gives a rule of an operation of the agent 20 for each of the plurality of agents 20. The multi-agent model 10 generates a virtual space 30 in which each agent 20 operate. The virtual space 30 provides an environment for the target event. The multi-agent model 10 simulates the operation of each agent 20 in the virtual space by using the agent model 21.

The agent model 21 of each agent 20 has parameters 22. The parameter 22 is a characteristic value that characterizes the operation of the agent 20. For example, when the target event is a people flow, the parameter 22 is a moving speed, a recognition range, an operation speed, or the like.

The multi-agent simulation by the multi-agent model 10 can be applied to, for example, development of products and services. In particular, if the multi-agent simulation can faithfully reproduce the actual events, the lead time required for trial production and verification of development can be shortened, and the development can be speeded up.

In order to execute a multi-agent simulation that more faithfully reproduces a real event, it is necessary to appropriately estimate the parameters 22 of the multi-agent model 10. As described above, the multi-agent model 10 has the parameter 22 for each of the agent models 21 of the plurality of agents 20, and thus the number of estimated parameters 22 is very large. The parameters 22 may also influence each other. Therefore, if the parameters are estimated by brute force, the calculation time may become enormous due to combinatorial explosion.

The parameter estimation device according to the present embodiment enables the parameters 22 of the multi-agent model 10 to be effectively estimated. The parameter estimation device according to the present embodiment will be described below.

### 2. Parameter Estimation Device

### 2-1. Configuration

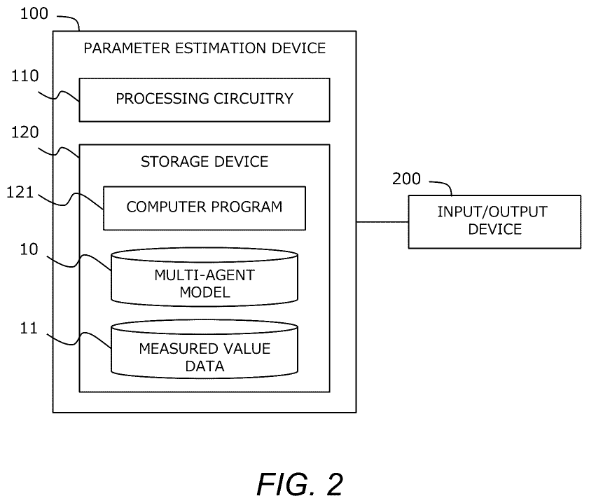

FIG. 2 is a diagram showing an example of a hardware configuration of the parameter estimation device 100 according to the present embodiment. The parameter estimation device 100 is a computer including processing circuitry 110 and a storage device 120. The parameter estimation device 100 is connected to an input/output device 200 operated by a user. The input/output device 200 receives various inputs from the user to the parameter estimation device 100, and presents information of various outputs from the parameter estimation device 100 to the user by display or sound. The input/output device 200 is configured by, for example, a display, a speaker, a touch screen, a mouse, a keyboard, a touch pad, a switch, and the like. The parameter estimation device 100 may be a server accessible via a communication network (for example, the Internet). In this case, the input/output device 200 may be a user terminal connected to the parameter estimation device 100 via the communication network.

The processing circuitry 110 executes various kinds of processing. The processing circuitry 110 may be implemented as, for example, a general-purpose processor, a special-purpose processor, a central processing unit (CPU), a graphics processing unit (GPU), an application specific integrated circuit (ASIC), a field-programmable gate array (FPGA), an integrated circuit, a conventional circuit, or a combination of one or more of these. In general, a processor including transistors and other circuitry is an example of processing circuitry 110. The processing circuitry 110 may also be referred to as circuitry. The circuitry may be hardware programmed to implement or perform the functions described in this disclosure.

The storage device 120 stores various kinds of information necessary for execution of processing of the processing circuitry 110. The storage device 120 is configured by a recording medium such as a random access memory (RAM), a read only memory (ROM), a solid state drive (SSD), or a hard disk drive (HDD). The storage device 120 stores a computer program 121 executable by the processing circuitry 110. The computer program 121 is configured by a plurality of instructions describing processing to be executed by the processing circuitry 110. The computer program 121 may be recorded in a computer-readable recording medium. The processing circuitry 110 that executes the computer program 121 and the storage device 120 cooperate with each other to realize the functions of the parameter estimation device 100.

The storage device 120 further stores the multi-agent model 10 and measured value data 11.

The measured value data 11 is data of actual measurement values acquired at predetermined sampling intervals with respect to a target event of multi-agent simulation by the multi-agent model 10. More specifically, the measured value data 11 is time-series data of actual operations of the components of the event expressed by each agent 20. In particular, the measured value data 11 can be represented by a data string {y t} (t=1, 2, . . . , N). N (an integer of 1 or more) represents the number of pieces of the measured value data 11. y t represents an actual measurement value at the time point t. For example, a case where the target event is a people flow is considered. In this case, the measured value data 11 is time-series data of the actual movement of the person represented by each agent 20, and y t represents the position of the person at the time point t.

The parameter estimation device 100 estimates the parameter 22 for the multi-agent model 10 stored in the storage device 120. As will be described later, the parameter estimation device 100 uses the measured value data 11 stored in the storage device 120 in the estimation of the parameter 22. The parameter estimation device 100 may be configured to receive an input of the multi-agent model 10 and the measured value data 11 from the user via the input/output device 200. The parameter estimation device 100 may be configured to store the multi-agent model 10 and the measured value data 11 input from the user in the storage device 120.

### 2-2. Estimation Process

The parameter estimation device 100 according to the present embodiment executes processing (hereinafter referred to as “estimation process”) of estimating the parameters 22 of the multi-agent model 10 using the ensemble Kalman filter. Hereinafter, an outline of the estimation process executed by the parameter estimation device 100 according to the present embodiment will be described.

The ensemble Kalman filter is a sequential data assimilation method for obtaining a likelihood distribution of a state vector by filtering based on observation data, with a linear or nonlinear state space model as a target. In particular, the ensemble Kalman filter obtains a likelihood distribution of a state vector from a distribution of a plurality of ensemble members. The ensemble Kalman filter is a known technique, and a more detailed description thereof will be omitted in the present disclosure.

The parameter estimation device 100 configures a state space model by the multi-agent model 10 including system noise and applies the ensemble Kalman filter. In particular, the parameter estimation device 100 handles the parameters 22 of each of the agents 20 included in the multi-agent model 10 as elements of the state vector. The state vector may further include a state (for example, a coordinate position, a speed, and the like in the virtual space 30) of each agent 20 as an element. The parameter estimation device 100 uses the measured value data 11 as the observation data.

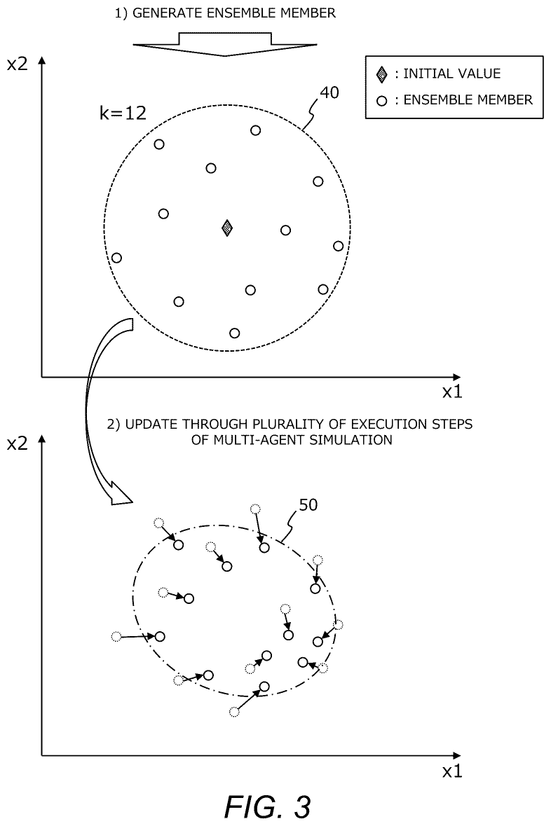

FIG. 3 is a conceptual diagram illustrating an overview of the estimation process performed by the parameter estimation device 100. In FIG. 3, the parameter 22 (state vector) is represented by two dimensional x=(x1, x2).

In the estimation process, the parameter estimation device 100 first generates a plurality of ensemble members for an initial value of the parameter 22. The parameter estimation device 100 generates a plurality of ensemble members by adding system noise to the initial value of the parameter 22. The generation range 40 of the plurality of ensemble members depends on the magnitude of the system noise. The magnitude of the system noise can be represented by the standard deviation or variance of the system noise. FIG. 3 shows a case where the number k of members of the plurality of ensemble members to be generated is 12.

Next, the parameter estimation device 100 acquires the updated distribution of the plurality of ensemble members through the plurality of execution steps of the multi-agent simulation by the multi-agent model 10 according to the algorithm of the ensemble Kalman filter. That is, in each execution step, the multi-agent simulation by the multi-agent model 10 is executed at predetermined execution intervals for each of the plurality of ensemble members, and the predicted distribution of the plurality of ensemble members is calculated. Then, the calculated predicted distribution is sequentially filtered (data assimilation) using the measured value data 11, and the distribution of the plurality of ensemble members is updated. When the measured value data 11 is a data string {y t} (t=1, . . . , N), the measured value data 11 used for filtering is an actual measurement value y t at the time point t of the calculated predicted distribution.

Then, the parameter estimation device 100 sets the likelihood distribution 50 of the parameter 22 represented by the updated distribution of the plurality of ensemble members as the estimation result of the estimation process. The likelihood distribution 50 of the parameter 22 indicates that the more the ensemble members are clustered, the higher the likelihood of the parameter 22. In this way, the parameter estimation device 100 according to the present embodiment estimates the parameter 22 by executing the estimation process. In particular, the ensemble Kalman filter performs matrix calculation on the state vector, and thus can collectively estimate the parameters 22 of the agent models 21. Therefore, even when the number of parameters 22 is large, the calculation time is not greatly affected. Therefore, the estimation process according to the present embodiment is effective in estimating the parameters 22 of the multi-agent model 10.

When the distribution of the plurality of ensemble members is updated, the execution interval of the plurality of execution steps of the multi-agent simulation can be made shorter than the sampling interval of the measured value data. For example, when the execution interval of the plurality of execution steps is set to be ½ of the sampling interval of the measured value data, the filtering using the measured value data 11 may be performed on the predicted distribution after the execution step is performed twice. However, the parameter estimation device 100 according to the present embodiment is configured to execute the estimation process by matching the execution interval of the plurality of execution steps with the sampling interval of the measured value data. With such a configuration, the accuracy of the estimation result (the likelihood distribution 50 of the parameter 22) of the estimation process can be improved. This is because a plurality of ensemble members can be updated by filtering using the measured value data 11 in each execution step. As a result, the standard deviation of the likelihood distribution 50 of the parameter 22 is reduced, and the accuracy of the estimation result is improved. On the other hand, if the execution interval of the plurality of execution steps is shorter than the sampling interval of the measured value data 11, filtering is not performed in the execution step in which the corresponding measured value data 11 does not exist. As a result, the standard deviation of the likelihood distribution 50 of the parameter 22 becomes large.

In the estimation process, the ensemble Kalman filter has two set values related to the estimation accuracy.

One of the set values related to the estimation accuracy is the number k of ensemble members. The greater the number k of ensemble members, the finer the distribution of the plurality of ensemble members. Therefore, by increasing the number k of ensemble members, the accuracy of the estimation result (the likelihood distribution 50 of the parameter 22) can be improved. On the other hand, as described above, when the distribution of the plurality of ensemble members is updated, the multi-agent simulation is executed for each of the plurality of ensemble members. Therefore, as the number k of ensemble members increases, the calculation cost for updating the distribution of the plurality of ensemble members increases. As described above, the setting of the number k of ensemble members is a trade-off between the improvement of the estimation accuracy and the reduction of the calculation cost.

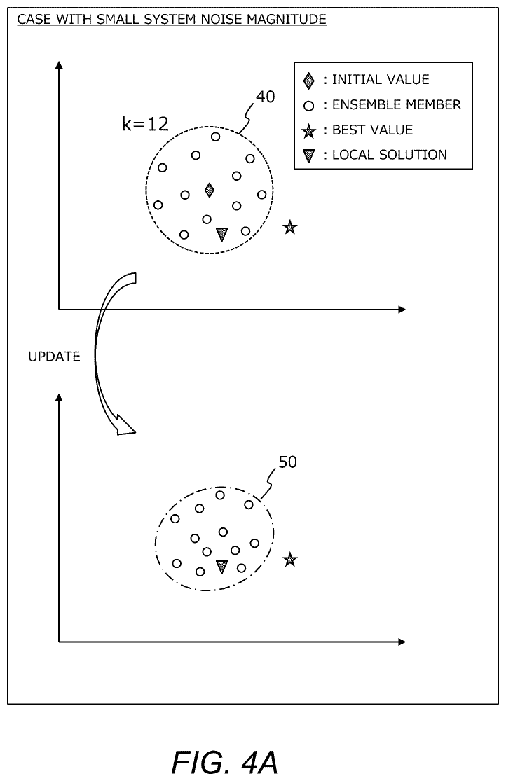

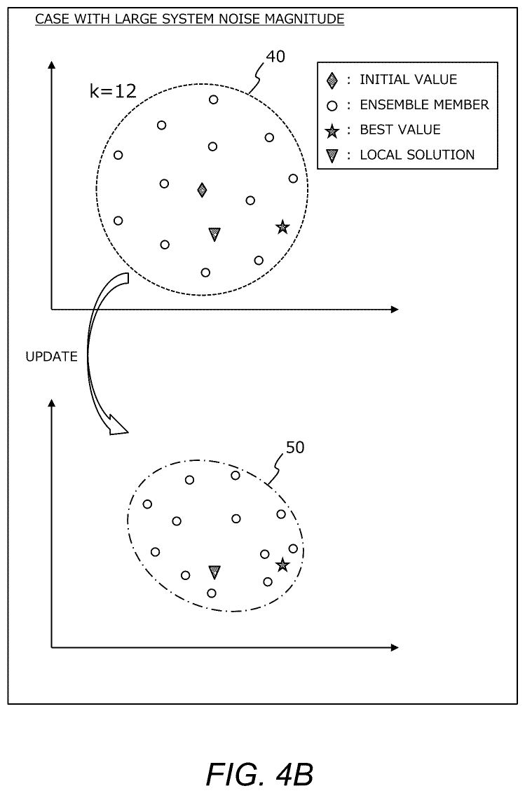

Another of the set values related to the estimation accuracy is the magnitude of system noise. The smaller the magnitude of the system noise, the smaller the generation range 40 of the plurality of ensemble members. This also reduces the variation in the distribution of the plurality of ensemble members after the update. Therefore, by reducing the magnitude of the system noise, the accuracy of the estimation result (the likelihood distribution 50 of the parameter 22) can be improved. On the other hand, the generation range 40 of the plurality of ensemble members can be considered as a search range of the parameter 22. Therefore, the smaller the magnitude of the system noise, the more likely it is that the distribution of the plurality of ensemble members is clustered in the local solution that is not the best value. This aspect will be described with reference to FIGS. 4A and 4B.

FIG. 4A shows a case where the magnitude of the system noise is small. In this case, as shown in FIG. 4A, the generation range 40 of the plurality of ensemble members becomes small. AS a result, the generation range 40 does not include the best value, but includes only the local solution. Thus, the plurality of ensemble members after the update are distributed so as to be accumulated in the local solution. On the other hand, the variation in the distribution of the plurality of ensemble members becomes small. As a result, the likelihood distribution 50 of the parameter 22 is calculated such that the likelihood of the parameter 22 becomes high in the local solution, although the standard deviation is small.

FIG. 4B shows a case where the magnitude of the system noise is large. In this case, as shown in FIG. 4B, the generation range 40 of the plurality of ensemble members becomes large. As a result, the generation range 40 includes both the local solution and the best value. Thus, the plurality of ensemble members after the update are distributed even in the vicinity of the best value without being clustered in the local solution. On the other hand, the variation in the distribution of the plurality of ensemble members becomes large. As a result, the likelihood distribution 50 of the parameters 22 is calculated to include the best values, avoiding the local solution, although with a large standard deviation.

As described above, the setting of the magnitude of the system noise is a trade-off between the improvement of the estimation accuracy and the avoidance of the local solution.

As described above, the number k of ensemble members and the magnitude of system noise each include elements (calculation cost and avoidance of local solution) that are in a trade-off relationship with improvement in estimation accuracy. Therefore, it is difficult to sufficiently ensure the estimation accuracy, the calculation cost, and the avoidance of the local solution in one estimation process. For example, when the magnitude of the system noise is set to be large so that the local solution can be avoided, the variation in the distribution of the plurality of ensemble members becomes large. In order to secure sufficient estimation accuracy under the variation, the number k of ensemble members is set to be considerably large. This results in an excessive calculation cost. On the other hand, when the number k of ensemble members is set to be small so as to suppress the calculation cost, the distribution of the plurality of ensemble members becomes rough. In order to ensure sufficient estimation accuracy under the rough distribution, the magnitude of the system noise is set to be considerably small. In this case, it is difficult to avoid a local solution.

Therefore, in order to address the above problem, the parameter estimation device 100 according to the present embodiment is configured to repeatedly execute the estimation process a plurality of times. The initial value of the parameter 22 when the estimation process is repeated is set using the estimation result of the previous estimation process. Furthermore, the parameter estimation device 100 according to the present embodiment is configured to adjust the set value of the ensemble Kalman filter for each of the plurality of iterations of the estimation process. Specifically, in the first iteration, the parameter estimation device 100 sets the estimation accuracy to be low, that is, the number of ensemble members to be small and the magnitude of the system noise to be large. The parameter estimation device 100 adjusts the set value so that the estimation accuracy is gradually improved for each of the plurality of iterations of the estimation process. That is, the parameter estimation device 100 performs at least one of increasing the number of ensemble members from the number of members in the estimation process in the previous iteration and decreasing the magnitude of system noise from the magnitude of system noise in the estimation process in the previous iteration. Thus, in the estimation process related to the first iteration, the avoidance of the local solution can be achieved with a low calculation cost. Furthermore, since the estimation accuracy is gradually improved for each of the plurality of iterations of the estimation process, it is possible to estimate the parameter 22 while achieving the estimation accuracy, the calculation cost, and the avoidance of the local solution.

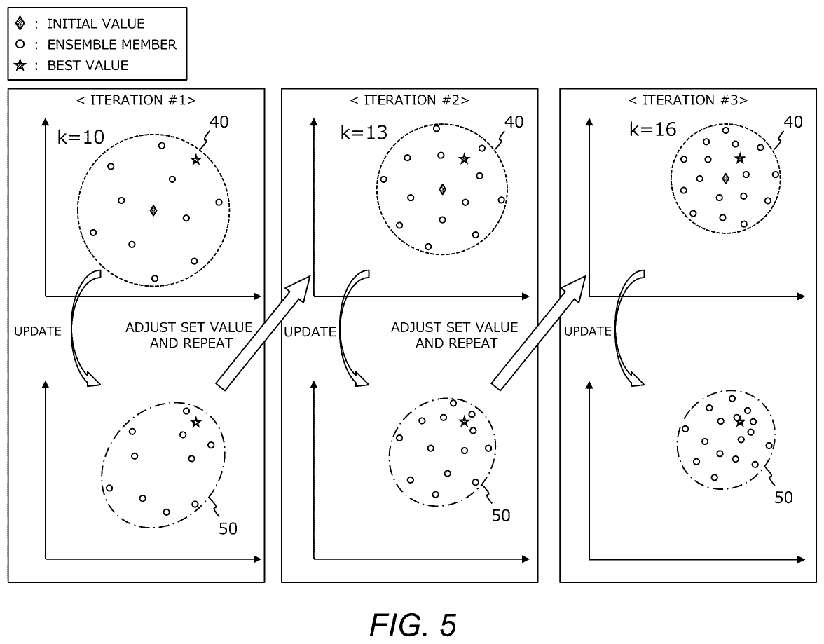

FIG. 5 is a conceptual diagram illustrating an example of a case where the parameter estimation device 100 according to the present embodiment estimates the parameter 22 by repeatedly executing the estimation process a plurality of times. FIG. 5 illustrates a case where the estimation process is repeated three times (iteration #1, iteration #2, and iteration #3). In the example illustrated in FIG. 5, in the estimation process (iteration #1) related to the first iteration, the number k of ensemble members is set to be small, and the magnitude of the system noise is set to be large. As a result, the likelihood distribution 50 of the parameter 22 for iteration #1 is calculated to include the best value, although the standard deviation is large. In the estimation process (iteration #2) related to the next iteration, the initial value of the parameter 22 is set using the estimation result of the estimation process (iteration #1) related to the previous iteration. For example, the value of the parameter 22 having the highest likelihood from the likelihood distribution 50 of the parameter 22 is set as the initial value. Alternatively, the initial value of the parameter 22 may be set probabilistically based on the likelihood distribution 50 of the parameter 22. In addition, in the iteration #2, the number k of ensemble members increases and the magnitude of system noise decreases with respect to the iteration #1. As a result, the likelihood distribution 50 of the parameter 22 related to the iteration #2 is calculated to have higher accuracy and include the best value compared to the likelihood distribution 50 of the iteration #1. Similarly, the likelihood distribution 50 of the parameter 22 related to the iteration #3 is calculated to have higher accuracy and include the best value compared to the likelihood distribution 50 of the iteration #2.

In this way, the parameter estimation device 100 according to the present embodiment can effectively estimate the parameters 22 of the multi-agent model 10.

### 2-3. Processing Flow

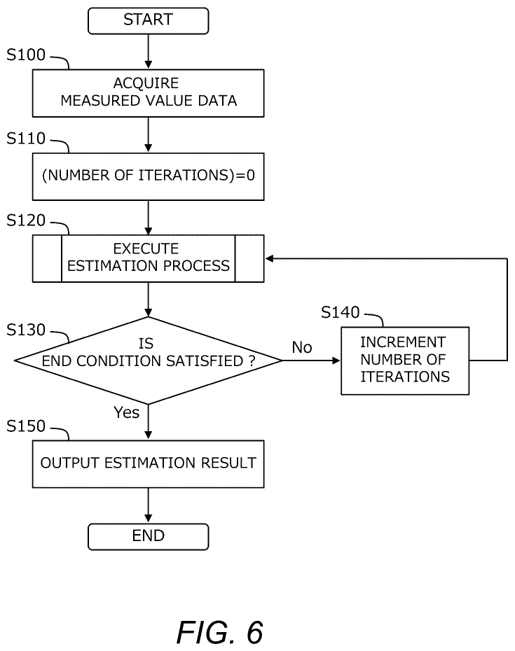

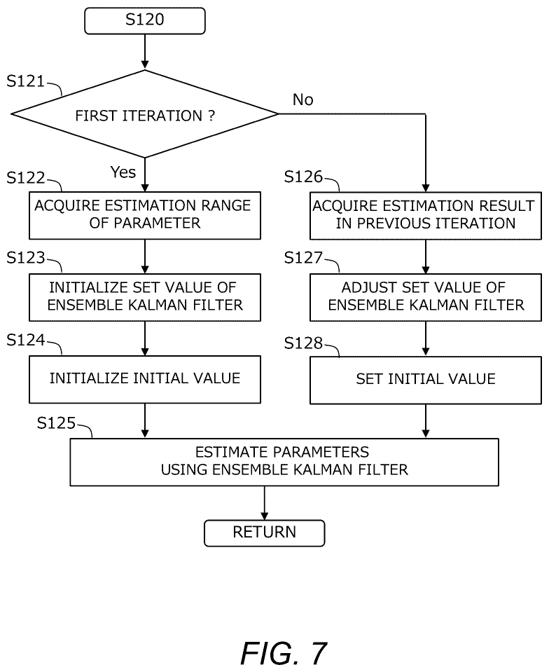

FIGS. 6 and 7 are flowcharts illustrating a processing flow of processing executed by the parameter estimation device 100 according to the present embodiment. Each process in the process flows illustrated in FIGS. 6 and 7 is executed by the processing circuitry 110.

First, in step S100, the processing circuitry 110 acquires the measured value data 11 from the storage device 120.

Next, in step S110, the processing circuitry 110 initializes the number of iterations of the estimation process.

Next, in step S120, the processing circuitry 110 executes the estimation process. Here, the process performed by the processing circuitry 110 in step S120 will be described with reference to FIG. 7.

In step S121, the processing circuitry 110 determines whether or not the estimation process is the estimation process related to the first iteration. When the number of iterations is 0, the processing circuitry 110 determines that the estimation process is the estimation process related to the first iteration. When the number of iterations is equal to or greater than 1, the processing circuitry 110 determines that the estimation process is not the estimation process related to the first iteration. When it is determined that the estimation process is the estimation process related to the first iteration (Yes in step S121), the process proceeds to step S122. When it is determined that the estimation process is not the estimation process related to the first iteration (No in step S121), the process proceeds to step S126.

In step S122, the processing circuitry 110 acquires an estimation range of the parameter 22. The estimation range of the parameter 22 is a range that is assumed in advance as a value that the best value of the parameter 22 can take. The estimation range of the parameter 22 may be stored in the storage device 120 in advance. The parameter estimation device 100 may be configured to receive an input of the estimation range of the parameter 22 from the user via the input/output device 200.

After step S122, next, in step S123, the processing circuitry 110 initializes the set value of the ensemble Kalman filter. The initial setting of the system noise is performed based on the estimation range of the parameter 22. Specifically, the processing circuitry 110 sets the magnitude of the system noise in accordance with the magnitude of the difference between the maximum value and the minimum value of the estimation range of the parameter 22. For example, the standard deviation of the system noise is set to (maximum value-minimum value)/10. By providing the initial setting of the system noise in this way, it is possible to make the generation range 40 of at least a plurality of ensemble members include the best value in the estimation process. The initial setting of the number k of ensemble members may be a predetermined value. The parameter estimation device 100 may be configured to receive an input of an initial setting of the number of members k from the user via the input/output device 200. Alternatively, the initial setting of the number k of ensemble members may be appropriately set in consideration of calculation cost. For example, when the maximum number of iterations of the estimation process is set in advance, the value of the number of members k is set to a value such that the product of the number of members k and the maximum number of iterations is equal to or less than a predetermined value.

After step S123, next, in step S124, the processing circuitry 110 initializes the initial value of the parameter 22. The initial value of the parameter 22 is initially set based on the estimated range of the parameter 22. Specifically, the median value of the estimation range of the parameter 22 is set as the initial value of the parameter 22. By giving the initial value of the parameter 22 in this way, it is possible to suppress the initial value of the parameter 22 from excessively deviating from the best value in the estimation process related to the first iteration. After step S124, the process proceeds to step S125.

In step S125, the processing circuitry 110 estimates the parameters 22 using the ensemble Kalman filter based on the measured value data 11. The processing circuitry 110 acquires the likelihood distribution 50 of the parameter 22 as an estimation result as referenced in FIG. 3. After step S125, the current estimation process is ended.

In step S126, the processing circuitry 110 acquires the estimation result of the estimation process in the previous iteration.

After step S126, next, in step S127, the processing circuitry 110 adjusts the set value of the ensemble Kalman filter. Specifically, the processing circuitry 110 performs at least one of increasing the number k of ensemble members from the number k of members in the estimation process in the previous iteration and decreasing the magnitude of system noise from the magnitude of system noise in the estimation process in the previous iteration. For example, the processing circuitry 110 increases the number k of ensemble members by a predetermined value (for example, 1). Similarly, the processing circuitry 110 reduces the standard deviation of the system noise by a predetermined value. Alternatively, when the maximum value of the number of iterations of the estimation process and the maximum value of the number k of ensemble members are determined in advance, the processing circuitry 110 may give the amount of increase of the number k of members so that the number k of members becomes the maximum value in the estimation process related to the final iteration. Similarly, the minimum value of the magnitude of the system noise may be determined in advance.

After step S127, next, in step S128, the processing circuitry 110 sets the initial value of the parameter 22. The initial value of the parameter 22 is set using the estimation result of the estimation process in the previous iteration. For example, the value of the parameter 22 having the highest likelihood from the likelihood distribution 50 of the parameter 22 acquired as the previous estimation result is set as the initial value. Alternatively, the initial value of the parameter 22 may be set probabilistically based on the likelihood distribution 50 of the parameter 22. After step S128, the process proceeds to step S125. The process related to step S125 is as described above.

In this way, in step S120, the processing circuitry 110 executes the estimation process.

The process performed by the processing circuitry 110 will be described with reference to FIG. 6 again. After step S120, next, in step S130, the processing circuitry 110 determines whether or not an end condition is satisfied. The processing circuitry 110 is configured to repeatedly execute the estimation process until the end condition is satisfied. That is, when the end condition is not satisfied (step S130; No), the processing circuitry 110 increments the number of iterations (step S140) and executes the estimation process again (step S120). The end condition may be set as appropriate. The end condition includes that the number of iterations is equal to or greater than a predetermined number of times, that the variance of the likelihood distribution of the parameter 22 is equal to or less than a predetermined value, that the set values of the number of members k and the system noise are the maximum value and the minimum value, respectively, and the like.

When the end condition is satisfied (Yes in step S130), the processing circuitry 110 outputs the estimation result of the parameter 22 by the estimation process to the input/output device 200 (step S150), and ends the processing.

### 3. Effect

As described above, according to the present embodiment, the estimation process of estimating the parameter 22 using the ensemble Kalman filter based on the measured value data 11 is repeatedly executed a plurality of times. The ensemble Kalman filter performs matrix calculation on a state vector having the parameters 22 as elements, and thus can collectively estimate the parameters 22 of the agent models 21. Therefore, the present embodiment can effectively estimate the parameters 22 of the multi-agent model 10. Furthermore, according to the present embodiment, the set value of the ensemble Kalman filter is adjusted so that the estimation accuracy is gradually improved for each of the plurality of iterations of the estimation process. That is, at least one of increasing the number k of ensemble members from the number k of members in the estimation process in the previous iteration and decreasing the magnitude of the system noise from the system noise in the estimation process in the previous iteration is performed. This enables estimation of the parameter 22 while achieving both the estimation accuracy, the calculation cost, and avoidance of a local solution. As a result, according to the present embodiment, it is possible to effectively estimate the parameters 22 of the multi-agent model 10.

What is claimed is:

1. A parameter estimation device for estimating a parameter of a simulation model that executes a multi-agent simulation, comprising:
processing circuitry, wherein
the processing circuitry is configured to:
acquire measured value data related to a target event of the multi-agent simulation; and
repeatedly execute an estimation process for estimating the parameter using an ensemble Kalman filter based on the measured value data through a plurality of execution steps of the multi-agent simulation a plurality of times, and wherein
in the estimation process, the processing circuitry is configured to:
perform at least one of increasing a number of ensemble members of the ensemble Kalman filter from the number of ensemble members in the estimation process in a previous iteration and decreasing magnitude of system noise of the ensemble Kalman filter from the system noise in the estimation process in a previous iteration; and
set an initial value of the parameter using an estimation result of the parameter by the estimation process in a previous iteration.

2. The parameter estimation device according to claim 1, wherein
in the estimation process in a first iteration, the processing circuitry is configured to acquire an estimation range of the parameter and set a median value of the estimation range as the initial value of the parameter.

3. The parameter estimation device according to claim 2, wherein
in the estimation process in the first iteration, the processing circuitry is further configured to set the magnitude of the system noise of the ensemble Kalman filter in accordance with magnitude of difference between a maximum value and a minimum value of the estimation range.

4. The parameter estimation device according to claim 1, wherein
the processing circuitry is further configured to execute the estimation process by matching an execution interval of the plurality of execution steps of the multi-agent simulation with a sampling interval of an actual measurement value of the measured value data.

5. The parameter estimation device according to claim 1, wherein
the parameter includes a characteristic value characterizing an operation of each agent included in the simulation model, and
the measured value data includes time series data of actual operation of a component of the event corresponding to each of the agent.

6. A parameter estimation method for estimating a parameter of a simulation model that executes a multi-agent simulation by a computer, the parameter estimation method comprising:
acquiring measured value data related to a target event of the multi-agent simulation; and repeatedly executing an estimation process for estimating the parameter using an ensemble Kalman filter based on the measured value data through a plurality of execution steps of the multi-agent simulation a plurality of times, wherein
the estimation process includes:
performing at least one of increasing a number of ensemble members of the ensemble Kalman filter from the number of ensemble members in the estimation process in a previous iteration and decreasing magnitude of system noise of the ensemble Kalman filter from the system noise in the estimation process in a previous iteration; and
setting an initial value of the parameter using an estimation result of the parameter by the estimation process in a previous iteration.
